(19) United States
(12) Patent Application Publication
(10) Pub. No.: US 2008/0253259 A1
(43) Pub. Date: Oct. 16, 2008

(54) Optical Device With Wavefront Modifier

(75) Inventor: Hendrik Josephus Goossens, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,178

(22) PCT Filed: Jan. 5, 2005
(86) PCT No.: PCT/IB05/00039

§ 371 Date: Jul. 14, 2006

(30) Foreign Application Priority Data
Jan. 19, 2004 (EP) 04300025.6

(51) Int. Cl. G11B 7/135

(52) U.S. Cl. 369/112.01

(57) ABSTRACT

An optical device comprises a wavefront modifier for introducing a wavefront modification in a radiation beam. The wavefront modifier comprises a first optical element (110) and a second optical element (111). The two optical elements are arranged in such a way that a suitable alternative movement of the first optical element leads to a translation of the second optical element by means of a stick-slip effect. This allows obtaining the desired mutual displacement between the two optical elements.

### FIELD OF THE INVENTION

The present invention relates to an optical device comprising a wavefront modifier for introducing a wavefront modification in a radiation beam.

The present invention also relates to a method of changing properties of a wavefront modifier.

The present invention is particularly relevant for an optical disc apparatus for recording to and reading from an optical disc, e.g. a CD, a DVD or a Blu-Ray Disc (BD) recorder and/or player.

### BACKGROUND OF THE INVENTION

Patent application WO 03/052755 describes an optical device comprising a wavefront modifier. The wavefront modifier comprises a first element having a first aspheric surface and a second element having a second aspheric surface, the first and second elements being mutually linearly movable for introducing a wavefront modification in a radiation beam. A mutual linear displacement of the two elements results in the generation of a wavefront modification in the radiation beam passing through the wavefront modifier.

In order to generate a wavefront modification, at least one of the two elements has to be translated. In order to achieve such a translation, the optical device of WO 03/052755 comprises positioning means attached to the first and second elements. These positioning means includes for example control means formed by an electromagnet, fixed elements and a spring. As a consequence, such positioning means are bulky, because they require a support element as well as coils. Furthermore, energy has to be provided to the electromagnet in order to keep the first and second elements in a given position, which makes the power consumption of the optical device relatively large.

### SUMMARY OF THE INVENTION

It is an object of the invention to provide an optical device comprising a wavefront modifier, which optical device is compact and has a relatively low power consumption.

To this end, the invention proposes an optical device comprising a wavefront modifier for introducing a wavefront modification in a radiation beam, said wavefront modifier comprising a first optical element and a second optical element arranged in such a way that a suitable alternative movement of the first optical element leads to a translation of the second optical element by means of a stick-slip effect.

According to the invention, the first and second optical elements have a contact surface chosen such that it delivers a given friction force, which leads to a stick-slip effect when a suitable alternative movement is imparted to the first optical element. Due to this stick-slip effect, the second optical element is translated while the first optical element remains in a given mean position. Hence, the mutual linear displacement of the first and second elements results from an alternative movement of the first optical element. As a consequence, only an alternative movement has to be imparted to the first optical element. Such an alternative movement may be imparted by means of a relatively compact system, such as a piezoelectric element attached to the first optical element. This makes the optical device compact. Actually, the means for introducing a wavefront modification approximately have the size of the first and second optical elements, because the first optical element itself imparts a translation movement to the second optical element. Furthermore, once the alternative movement of the first optical element is stopped, the second optical element remains in its relative position compared to the first optical element, due to the friction force between the first and second elements. It is therefore not needed to provide energy in order to keep the first and second elements in a given position. The power consumption of the optical scanning device is therefore relatively low.

In an advantageous embodiment, the first and the second optical element are arranged in such a way that a suitable alternative movement of the first optical element in a first direction leads to a translation of the second optical element in said first direction and a suitable alternative movement of the first optical element in a second direction leads to a translation of the second optical element in said second direction.

According to this advantageous embodiment, the wavefront modifier can introduce wavefront modifications in two directions, such as a radial and a tangential direction. This allows compensating coma in two directions, which is required, for example for correcting aberrations due to a tilt of an information carrier with respect to the optical axis of the objective lens of an optical scanning device.

In a preferred embodiment, the first and the second optical element are further arranged in such a way that a suitable alternative movement of the second optical element leads to a translation of the first optical element by means of a stick-slip effect. According to this preferred embodiment, the wavefront modifier can also introduce wavefront modifications in two directions, which allows compensating coma in two directions

Advantageously, the optical device further comprises means for guiding the second optical element. This ensures that the translation of the second optical element follows a predetermined direction.

The invention also relates to a method of changing properties of a wavefront modifier comprising a first optical element and a second optical element, said method comprising the step of imparting a suitable alternative movement to the first optical element in order to translate the second optical element by means of a stick-slip effect.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows an optical device in accordance with the invention, comprising a wavefront modifying portion;

FIG. 2a is a perspective view of the wavefront modifying portion of the optical device of FIG. 1 and FIG. 2b is an exploded view of FIG. 2a;

FIGS. 3a and 3b are cross sections of the wavefront modifying portion of FIG. 2a;

FIG. 4a shows the alternative movement of the first optical element of FIG. 2a and FIG. 4b shows the resulting translation of the second optical element of FIG. 2a;

FIG. 5 is an exploded perspective view of the wavefront modifying portion of the optical device of FIG. 1 in an advantageous embodiment of the invention;

FIG. 6 is an exploded perspective view of the wavefront modifying portion of the optical device of FIG. 1 in a preferred embodiment of the invention.

### DETAILED DESCRIPTION OF THE INVENTION

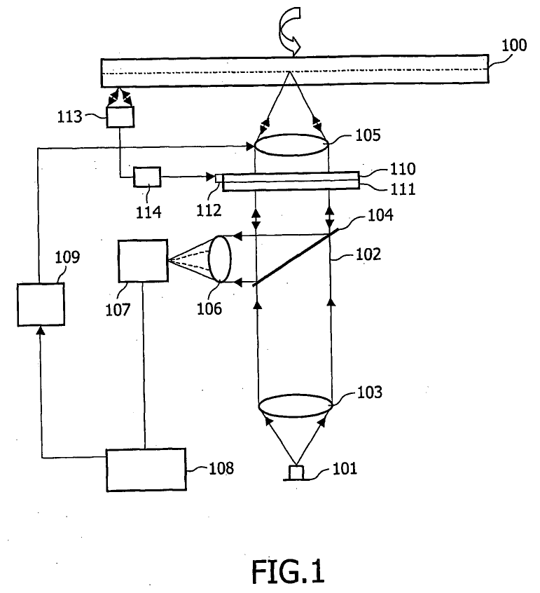

An optical device according to the invention is depicted in FIG. 1. Such an optical device comprises a radiation source 101 for producing a radiation beam 102, a collimator lens 103, a beam splitter 104, an objective lens 105, a servo lens 106, detecting means 107, measuring means 108, and a controller 109. This optical device is intended for scanning an information carrier 100. The optical device further comprises a wavefront modifier comprising a first optical element 110 and a second optical element 111. A piezoelectric element 112 is attached to the first optical element 110. The wavefront modifier and the piezoelectric element 112 form a wavefront modifying portion.

The optical device further comprises a coma detector 113 and a control circuit 114 which controls the piezoelectric element 112. Such a coma detector 113 and control circuit 114 are described, for example, in WO 03/052755.

During a scanning operation, which may be a writing operation or a reading operation, the information carrier 100 is scanned by the radiation beam 102 produced by the radiation source 101. The collimator lens 103 and the objective lens 105 focus the radiation beam 102 on an information layer of the information carrier 100. During a scanning operation, a focus error signal may be detected, corresponding to an error of positioning of the radiation beam 102 on the information layer. This focus error signal may be used for correcting the axial position of the objective lens 105, so as to compensate for a focus error of the radiation beam 102. A signal is sent to the controller 109, which drives an actuator in order to move the objective lens 105 axially.

The focus error signal and the data written on the information layer are detected by the detecting means 107. The radiation beam 102, reflected by the information carrier 100, is transformed into a parallel beam by the objective lens 105, and then reaches the servo lens 106, by means of the beam splitter 104. This reflected beam then reaches the detecting means 107.

The wavefront modifier enables introducing wavefront modification in the radiation beam 102. This may be required if coma aberration is detected by the coma detector 113. The wavefront modifier comprises a first optical element 110 and a second optical element 111 which are designed in such a way that they introduce a wavefront aberration when a relative displacement occurs between the first and the second optical element 110 and 111. The invention applies to any wavefront modifier comprising two optical elements, such as a wavefront modifier as described in WO 03/052755 or a simpler wavefront modifier as described in “Lateral shift variable aberration generators”, Applied Optics Vol. 38 (1999) pp. 86-90. How the relative displacement between the first optical element 110 and the second optical element 111 is created is described in the next figures.

Although the optical device presented in FIG. 1 is an optical scanning device for scanning an information carrier, the invention may be applied in any optical device comprising a wavefront modifier with two optical elements. For example, the invention may be applied in a zoom lens of a photo camera. In this case, the wavefront modifier generates a wavefront modification in the form of defocus in order to change the focal length of the zoom lens, thereby making the focal length adjustable.

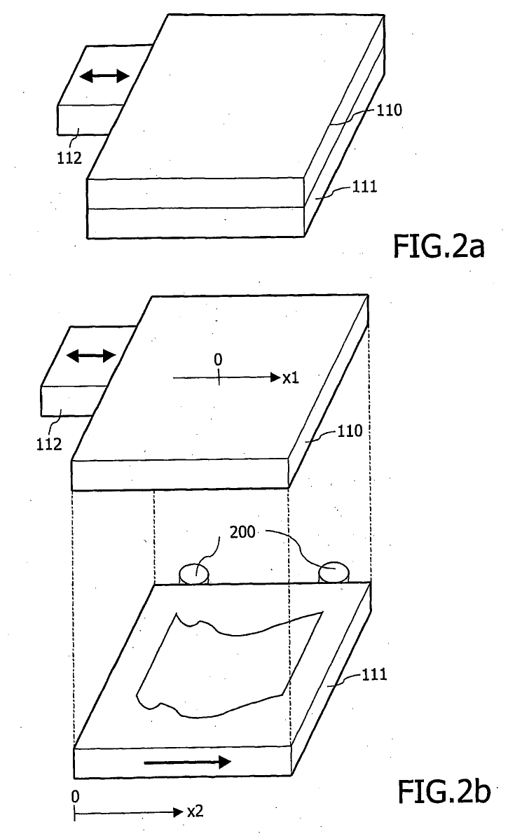

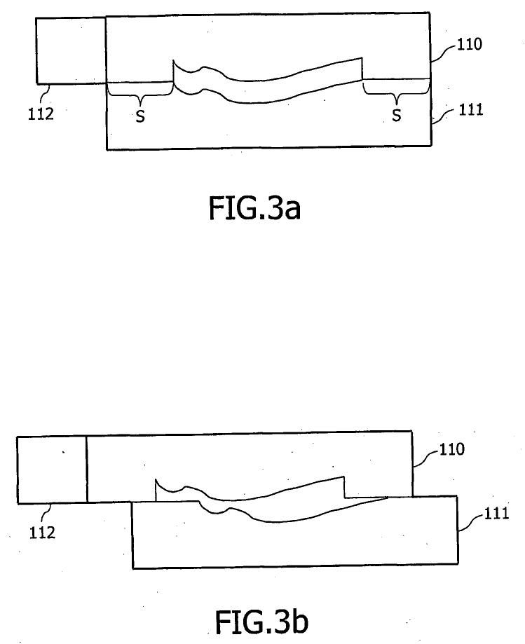

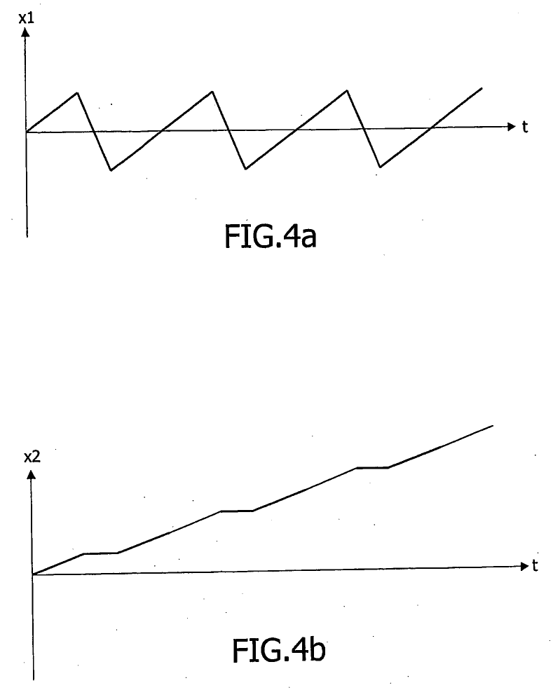

FIGS. 2a and 2b shows the wavefront modifying portion. The first optical element 110 and the second optical element 111 have a common sliding surface, as can be seen in FIG. 2a and will be explained in more detail with reference to FIG. 3. When a suitable alternative movement is imparted to the first optical element 110, a translation of the second optical element 111 occurs, by means of a stick-slip effect. The friction force of the common sliding surface is chosen in such a way that the stick-slip effect occurs when the suitable alternative movement is imparted to the first element 110. This is explained in more details with reference to FIGS. 4a and 4b.

As a consequence, the second element 111 is translated by imparting an alternative movement to the first element 110. Hence, the optical properties of the wavefront modifier are modified, as explained, for example, in WO 03/052755. The translation of the second element 111 may have a relatively large stroke, such as a few centimeters, even if the stroke of the first element 110 is relatively low, such as a few micrometers. Hence, a compact system is used in order to move the first element 110. In the example of FIGS. 2a and 2b, a piezoelectric element 112 is used. However, another moving device may be used, such as a short stroke electromagnetic actuator.

In the example of FIGS. 2a and 2b, guiding means 200 are provided for guiding the second optical element 111. The guiding means 200 ensure that the second optical element 111 is translated in a predetermined direction. In this example, roller bearings are used as guiding means 200. Other guiding means may be used, such as elastic bearings. The guiding means are fixed to the fixed part of the optical device.

FIG. 3a is a cross section of the wavefront modifying portion of FIG. 2a, when the second element 111 faces the first element 110. The two optical elements 110 and 111 each have an aspheric surface and a plane surface. The plane surfaces define a common sliding surface S. In the position of FIG. 3a, the wavefront modifier is a neutral element. FIG. 3b is a cross section of the wavefront modifying portion of FIG. 2a, when the second optical element 111 has been translated with respect to the first optical element 110. In this position, the wavefront modifier introduces a wavefront modification in a radiation beam passing through it. This is well known from those skilled in the art, and is thus not described further. Details on wavefront modification may be found, for example, in WO 03/052755.

FIG. 4a shows the alternative movement of the first optical element 110 and FIG. 4b shows the resulting movement of the second optical element 111. FIG. 4a represents the position x1 of the first optical element 110 as a function of the time, where x1 is a first axis defined in FIG. 2b. FIG. 4b represents the position x2 of the second optical element 111 as a function of the time, where x2 is a second axis defined in FIG. 2b. An alternative movement is imparted to the first optical element, in such a way that the first optical element remains in a same mean position, represented by x1=0. This alternative movement is relatively slow in a first direction, whereas it is relatively rapid in a second direction. The sliding surface between the first and the second optical element 110 and 111 is chosen in such a way that the relatively slow movement of the first optical element 110 leads to a translation of the second optical element 111, whereas the relatively rapid movement of the first optical element 110 does not lead to any movement of the second optical element 111. In other words, a suitable alternative movement of the first optical element 110 leads to a translation of the second optical element 111 by means of a stick-slip effect. The stick slip effect is well known from those skilled in the art. For example, U.S. Pat. No. 6,459,473 describes such a stick slip effect. In order to be arranged in such a way that a suitable alternative movement of the first optical element 110 leads to a translation of the second optical element 111 by means of a stick-slip effect, the first and second optical element 110 and 111 need a common sliding surface with a friction force that is chosen in order to give rise to said stick slip effect.

In order to impart the alternative movement to the first optical element 110, an input voltage is applied to the piezoelectric element 112, which voltage has a saw tooth waveform corresponding to the movement represented in FIG. 4a. Other input voltages may be used, which lead to different alternative movements of the first optical element 110, such as an impulse waveform.

As can be seen from FIGS. 4a and 4b, the second optical element 111 remains in its position when the input voltage is cut, i.e. when the movement of the first optical element 110 is stopped. As a consequence, the energy consumption of the optical device implementing such a wavefront modifying portion is relatively low, because no energy is required once the second optical element has reached its desired position.

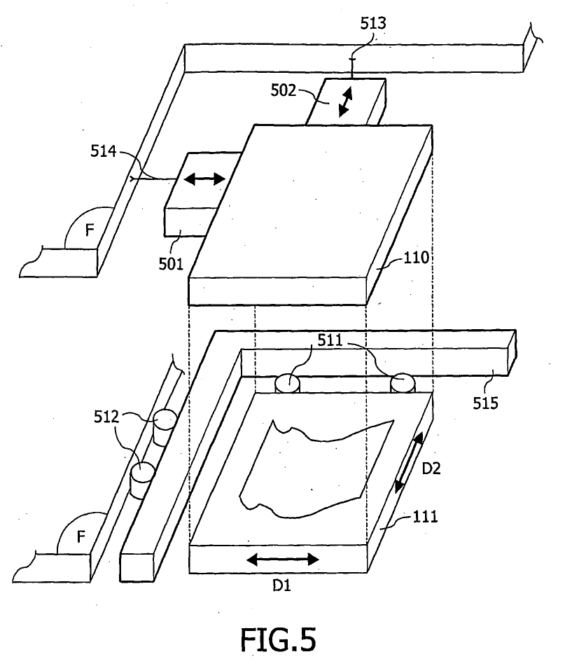

FIG. 5 shows a wavefront modifying portion in an advantageous embodiment of the invention. The wavefront modifying portion comprises the first optical element 110, the second optical element 111, a first piezoelectric element 501, a second piezoelectric element 502, first guiding means 511 and second guiding means 512. The first and second piezoelectric elements 501 and 502 are attached to the first optical element 110. According to this advantageous embodiment, the second optical element 111 can be translated in two different directions D1 and D2. This is particularly useful, especially in an optical scanning device for scanning an information carrier, as explained in WO 03/052755. When a linear mutual displacement in a first direction D1 is desired, a suitable input voltage is applied to the first piezoelectric element 501, such that an alternative movement is imparted to the first optical element 110, as described in FIG. 4a. In this case, the second piezoelectric element 502, which is attached to the first optical element 110, is also alternatively moved in direction D1. A first elastic element 513 is thus required between the second piezoelectric element 502 and the fixed parts F of the optical device. When a linear mutual displacement in a second direction D2 is desired, a suitable input voltage is applied to the second piezoelectric element 502, such that an alternative movement is imparted to the first optical element 110, which movement correspond to the movement as described in FIG. 4a, but according to the second direction D2. In this case, the first piezoelectric element 501, which is attached to the first optical element 110, is also alternatively moved in direction D2. A second elastic element 514 is thus required between the first piezoelectric element 501 and the fixed parts F of the optical device. The first and second guiding means 511 and 512 ensure that the second optical element 111 follows the desired direction. The wavefront modifying portion further comprises an additional body 515, which allows the second optical element 111 to be displaced in the first and second directions D1 and D2. When the second optical element 111 is displaced in the first direction D1, the first guiding means 511 guide said second optical element 111, while the additional body 515 remain fixed. When the second optical element 111 is displaced in the second direction D2, the additional body 515, the first guiding means 511 and the second optical element 111 are guided by the second guiding means 512.

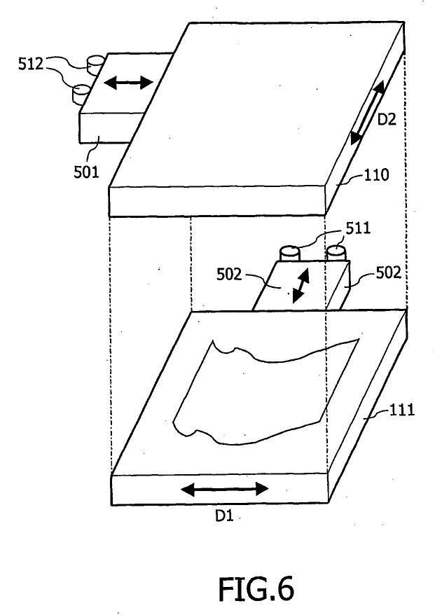

FIG. 6 shows a wavefront modifying portion in a preferred embodiment of the invention. The wavefront modifying portion comprises the first optical element 110, the second optical element 111, the first piezoelectric element 501, the second piezoelectric element 502, the first guiding means 511 and the second guiding means 512. The first piezoelectric element 501 is attached to the first optical element 110. The second piezoelectric element 502 is attached to the second optical element 111. According to this advantageous embodiment, a mutual linear displacement of the two optical elements 110 and 111 can be obtained in two different directions. When a linear mutual displacement in the first direction D1 is desired, a suitable input voltage is applied to the first piezoelectric element 501, such that an alternative movement is imparted to the first optical element 110, as described in FIG. 4a. When a linear mutual displacement in a second direction D2 is desired, a suitable input voltage is applied to the second piezoelectric element 502, such that an alternative movement is imparted to the second optical element 111, which movement correspond to the movement as described in FIG. 4a, but according to the second direction D2 and for the second optical element 111. The first and second guiding means 511 and 512 ensure that the second optical element 111 and the first optical element 110, respectively, follow the desired direction D1 or D2. According to this preferred embodiment, no elastic element and no additional body are required, as is the case in the embodiment shown in FIG. 5. Hence, the optical device according to this preferred embodiment is more compact.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical device comprising a wavefront modifier for introducing a wavefront modification in a radiation beam, said wavefront modifier comprising a first optical element (110) and a second optical element (111) arranged in such a way that a suitable alternative movement of the first optical element leads to a translation of the second optical element by means of a stick-slip effect.

2. An optical device as claimed in claim 1, wherein the first and the second optical element are arranged in such a way that a suitable alternative movement of the first optical element in a first direction leads to a translation of the second optical element in said first direction and a suitable alternative movement of the first optical element in a second direction leads to a translation of the second optical element in said second direction.

3. An optical device as claimed in claim 1, wherein the first and the second optical element are further arranged in such a way that a suitable alternative movement of the second optical element leads to a translation of the first optical element by means of a stick-slip effect.

4. An optical device as claimed in claim 3, wherein the first and the second optical element are arranged in such a way that a suitable alternative movement of the first optical element in a first direction leads to a translation of the second optical element in said first direction and a suitable alternative movement of the second optical element in a second direction leads to a translation of the first optical element in said second direction.

5. An optical device as claimed in claim 1, comprising a piezoelectric element (112) attached to the first optical element for imparting the suitable alternative movement to the first optical element.

6. An optical device as claimed in claim 1, further comprising means (200) for guiding the second optical element.

7. A method of changing properties of a wavefront modifier comprising a first optical element and a second optical element, said method comprising the step of imparting a suitable alternative movement to the first optical element in order to translate the second optical element by means of a stick-slip effect.

8. An optical scanning device as claimed in claim 1.

9. A photo camera as claimed in claim 1.
